(19) United States
(12) Patent Application Publication
(10) Pub. No.: US 2026/0288044 A1
(43) Pub. Date: Sep. 24, 2026

(54) IMAGE FORMING APPARATUS

(71) Applicant: KYOCERA Document Solutions Inc., Osaka (JP)

(72) Inventor: Koki YOKOYAMA, Osaka (JP)

(73) Assignee: KYOCERA Document Solutions Inc., Osaka (JP)

(21) Appl. No.: 19/566,808

(22) Filed: Mar. 13, 2026

(30) Foreign Application Priority Data
Mar. 18, 2025 (JP) 2025-043743

(51) Int. Cl. G03G 15/00; G03G 15/01; G03G 21/16

(52) U.S. Cl. CPC G03G 15/6514; G03G 21/1633; G03G 15/0189

(57) ABSTRACT

An image forming apparatus includes a conveying guide facing to a lower surface of a sheet fed from an opening on a main body housing, a supporting section being changed into a first state of the conveying guide supported at a predetermined position and a second state of the conveying guide lowered from the predetermined position, a sheet feed cartridge being provided below the conveying guide and being insertable/removable to the main body housing, an operation section being exposed when at least a part of the sheet feed cartridge is pulled out and receiving operation for changing the supporting section from the first state to the second state, a cover being provided openably/closably on the opening, and an engaging section being engaged with the operation section in the first state when the cover is closed, but being not engaged with the operation section when the cover is opened.

### INCORPORATION BY REFERENCE

This application is based on and claims the benefit of priority from Japanese Patent application No. 2025-043743 filed on Mar. 18, 2025, the entire contents of which are incorporated herein by reference.

### BACKGROUND

The present disclosure relates to an image forming apparatus.

An image forming apparatus having a function of feeding a sheet from a manual feed tray provided on a side surface of a main body housing is known. This type of image forming apparatus generally includes a pickup roller for picking up the sheet from the manual feed tray and a conveying path for conveying the picked-up sheet to an image forming section.

In the above-described configuration, there is a problem that it is difficult to remove the sheet when the sheet is clogged in the conveying path. As a configuration for solving this problem, for example, the following configuration is considered. In general, a sheet feed cartridge is provided below the manual feed conveying path. It may be configured so that a conveying guide forming a lower surface of the conveying path is lowered to a space after the sheet feed cartridge is pulled out. According to such configuration, the sheet can be removed by putting a hand in the space.

In this case, an operation portion for receiving operation for lowering the conveying guide is required, but if the operation portion is provided outside the main body housing, there is a possibility that a user may accidentally touch the operation portion when it is not necessary to lower the conveying guide. Therefore, it is necessary that the operation portion is exposed only when the sheet feed cartridge is pulled out.

However, in a case of a configuration in which the sheet feed cartridge can be extended to accommodate the sheet of legal size or the like, since the operation portion is exposed when the sheet feed cartridge is extended, there is a possibility that the user may erroneously lower the conveying guide during sheet feeding from the sheet feed cartridge, thereby stopping sheet feeding. Also, in a case of replenishing the sheet to the sheet feed cartridge or removing the sheet clogged in the inner side of the sheet feed cartridge, the operation portion is exposed by pulling out the sheet feed cartridge. If the conveying guide is erroneously lowered, it becomes an obstacle to work. In addition, if the conveying guide is erroneously lowered while a hand is inserted to remove the sheet, the conveying guide may come into contact with the hand.

### SUMMARY

An image forming apparatus in accordance with the present disclosure includes a conveying guide, a supporting section, a sheet feed cartridge, an operation section, a cover and an engaging section. The conveying guide faces to a lower surface of a sheet fed from an opening provided on a side surface of a main body housing. The supporting section is changed into a first state in which the conveying guide is supported at a predetermined position and a second state in which the conveying guide is lowered from the predetermined position. The sheet feed cartridge is provided below the conveying guide and is insertable/removable to the main body housing. The operation section is provided at a position exposed when at least a part of the sheet feed cartridge is pulled out and receives operation for changing the supporting section from the first state to the second state. The cover is provided openably/closably on the opening. The engaging section is engaged with the operation section at a position corresponding to the first state when the cover is closed, but is not engaged with the operation section when the cover is opened.

The above and other objects, features, and advantages of the present disclosure will become more apparent from the following description when taken in conjunction with the accompanying drawings in which a preferred embodiment of the present disclosure is shown by way of illustrative example.

### BRIEF DESCRIPTION OF THE DRAWINGS

FIG. 1 is a perspective view showing an external appearance of an image forming apparatus according to an embodiment of the present disclosure.

FIG. 2 is a right side view schematically showing internal structure of an image forming apparatus according to the embodiment of the present disclosure.

FIG. 3 is a plan view showing a conveying guide according to the embodiment of the present disclosure.

FIG. 4 is a left side view showing the conveying guide according to the embodiment of the present disclosure.

FIG. 5 is a left side view showing a supporting section in a first state according to the embodiment of the present disclosure.

FIG. 6 is a left side view showing the supporting section in a second state according to the embodiment of the present disclosure.

FIG. 7 is a perspective view showing a sheet feed cartridge in an extended condition according to the embodiment of the present disclosure.

FIG. 8 is a left side view showing the supporting section and an operation section in a conventional first state.

FIG. 9 is a left side view showing the supporting section and the operation section in a conventional second state.

FIG. 10 is a left side view showing the supporting section and the operation section in the first state according to the embodiment of the present disclosure.

FIG. 11 is a left side view showing the supporting section and the operation section in the second state according to the embodiment of the present disclosure.

FIG. 12 is an enlarged left side view of an engaging section of FIG. 10.

FIG. 13 is an enlarged left side view of the engaging section of FIG. 11.

### DETAILED DESCRIPTION

In the following, an image forming apparatus 1 according to an embodiment of the present disclosure will be described with reference to the accompanying drawings.

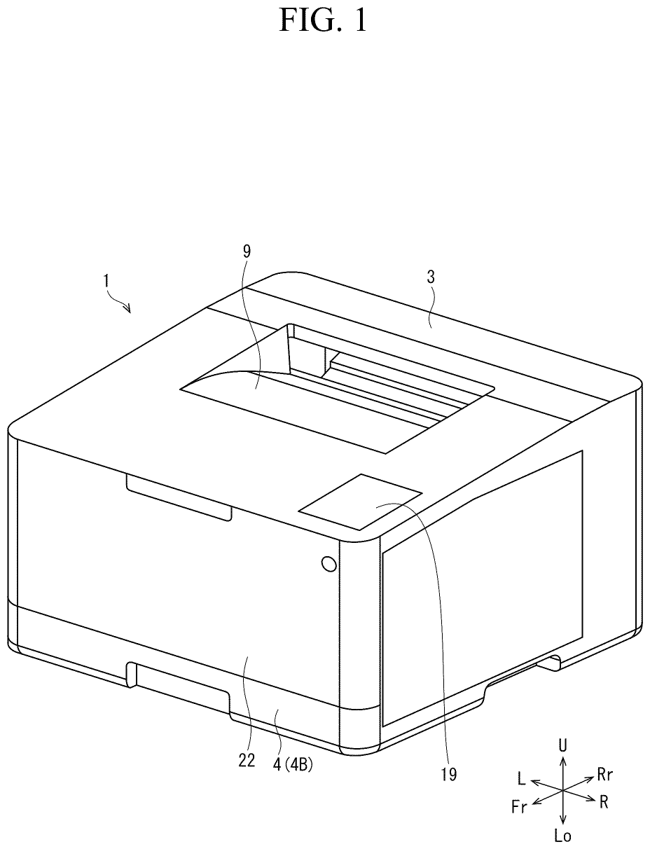

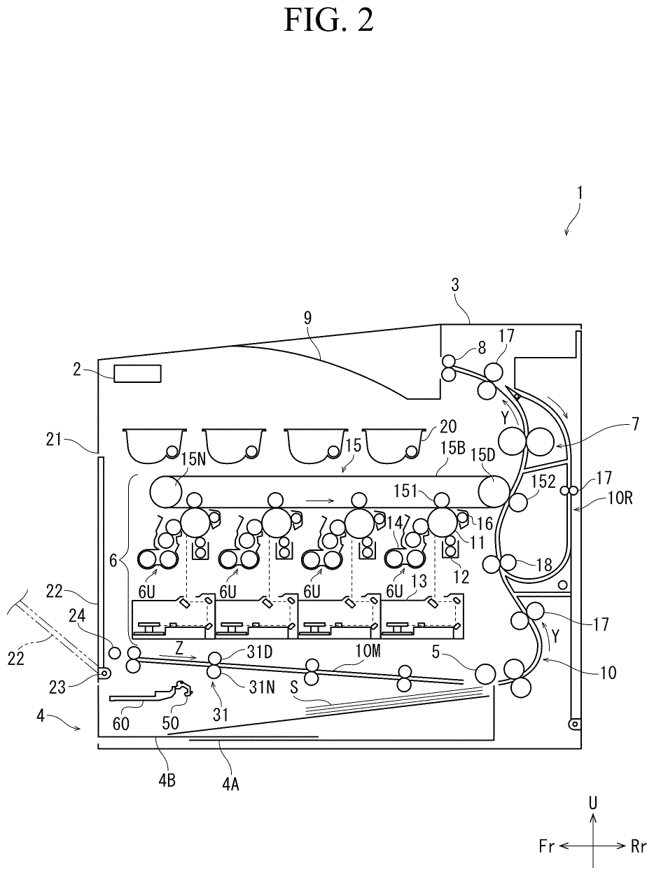

FIG. 1 is a perspective view showing an external appearance of the image forming apparatus 1. FIG. 2 is a right side view schematically showing internal structure of the image forming apparatus 1. In each drawing, U, Lo, L, R, Fr and Rr indicate an upper side, a lower side, a left side, a right side, a front side and a rear side, respectively. Incidentally, such directions are only defined for convenience of explanation.

### Image Forming Apparatus

The image forming apparatus 1 includes a rectangular parallelepiped main body housing 3. At a lower part of the inside of the main body housing 3, a sheet feed cartridge 4 in which a sheet S is stored and a sheet feeding roller 5 for feeding the sheet S backward from the sheet feed cartridge 4 are provided. Above the sheet feed cartridge 4, an image forming device 6 for forming a toner image by an electrophotographic system is provided, and, above and behind the image forming device 6, a fixing device 7 for fixing the toner image to the sheet S is provided. Above the fixing device 7, an ejecting roller 8 for ejecting the sheet S on which the toner image is fixed and an ejection tray 9 on which the ejected sheet S is stacked are provided.

Inside the main body housing 3, a conveying path 10 is provided from the sheet feeding roller 5 through the image forming device 6 and the fixing device 7 to the ejecting roller 8. The conveying path 10 is formed mainly with plate-like members facing to each other with a gap for passing the sheet S, and conveying rollers 17 for holding and conveying the sheet S are provided at a plurality of locations in the conveyance direction Y. At an upstream side of the image forming device 6 in the conveyance direction Y, a register roller 18 is provided. At a right side of the fixing device 7, an inverted conveying path 10R is provided. The inverted conveying path 10R branches from the conveying path 10 at a branch point located at a downstream side of the fixing device 7 in the conveyance direction Y, and joins the conveying path 10 at a junction point located at an upstream side of the register roller 18 in the conveyance direction Y.

At a front side surface of the main body housing 3, an opening 21 is provided. The opening 21 is provided with an openable/closable cover 22. A lower end part of the cover 22 is connected to the lower edge part of the opening 21 by using a hinge 23. At an end part on the hinge 23 side of the inner surface of the cover 22, a pickup roller 24 is provided. Behind the pickup roller 24, a manual feed conveying path 10M from the pickup roller 24 to the sheet feeding roller 5 is provided. The cover 22 also serves as a manual feed tray. When the sheet S is fed manually, the sheet S is stacked on an upper surface of the opened cover 22. In addition to general copy paper, envelopes and postcards can be manually fed.

The image forming device 6 includes four sets of image forming units 6U and an intermediate transfer unit 15. The image forming unit 6U is provided with a photosensitive drum 11 whose electric potential changes upon irradiation with light, a charging device 12 for charging the photosensitive drum 11, an exposure device 13 for emitting laser light corresponding to image data, a developing device 14 for supplying toner to the photosensitive drum 11, and a cleaning device 16 for removing the toner remaining on the photosensitive drum 11. The intermediate transfer unit 15 is provided with an endless intermediate transfer belt 15B wound around a driving roller 15D and a driven roller 15N, a primary transferring roller 151 facing to an inner peripheral surface of the intermediate transfer belt 15B at a position corresponding to the photosensitive drum 11 to generate a primary transfer bias, and a secondary transferring roller 152 facing to an outer peripheral surface of the intermediate transfer belt 15B at a position corresponding to the driving roller 15D to generate a secondary transfer bias. To the developing device 14, a toner container 20 for supplying the toner to the developing device 14 is connected. The image forming device 6 forms a color image by superposing toner images of four colors on the intermediate transfer belt 15B. Incidentally, the image forming apparatus 1 may include two sets, three sets, or five sets or more image forming units 6U.

The control unit 2 includes an arithmetic unit and a storage unit (not shown). The arithmetic unit is, for example, a CPU (Central Processing Unit). The storage unit includes a storage medium, such as ROM (Read Only Memory), RAM (Random Access Memory), and EEPROM (Electrically Erasable Programmable Read Only Memory). The arithmetic unit executes various processes by reading and executing control program stored in the storage unit. The control unit 2 may be realized only by an integrated circuit without using software.

In front of the ejection tray 9, a display operation unit 19 is provided. The display operation unit 19 includes a display panel, a touch panel provided superposed on a display surface of the display panel, and a keypad. The control unit 2 causes the display panel to display a screen representing an operation menu, status, and the like of the image forming apparatus 1, and controls each component of the image forming apparatus 1 according to operation detected by the touch panel and the keypad.

When an image forming job is inputted, the sheet feeding roller 5 feeds the sheet S from the sheet feed cartridge 4 to the conveying path 10, the register roller 18 whose rotation is stopped corrects skew of the sheet S, and the register roller 18 feeds the sheet S to the image forming device 6 at a predetermined timing. In the image forming device 6, the charging device 12 charges the photosensitive drum 11 to a predetermined electric potential, the exposure device 13 writes a latent image on the photosensitive drum 11, the developing device 14 forms the toner image by developing the latent image using the toner supplied from the toner container 20, the primary transferring roller 151 transfers the toner image to the intermediate transfer belt 15B, and the secondary transferring roller 152 transfers the toner image to the sheet S.

Subsequently, the fixing device 7 fuses the toner image while holding and conveying the sheet S to fix the toner image to the sheet S, and the ejecting roller 8 ejects the sheet S to the ejection tray 9. In a case of double-sided printing, the sheet S having the toner image fixed on a first surface is fed to the conveying path 10 via the inverted conveying path 10R, whereby the toner image is transferred to a second surface. When a manual feed is instructed, the pickup roller 24 picks up the sheet S from the cover 22 to the manual feed conveying path 10M, and the sheet S is fed to the conveying path 10.

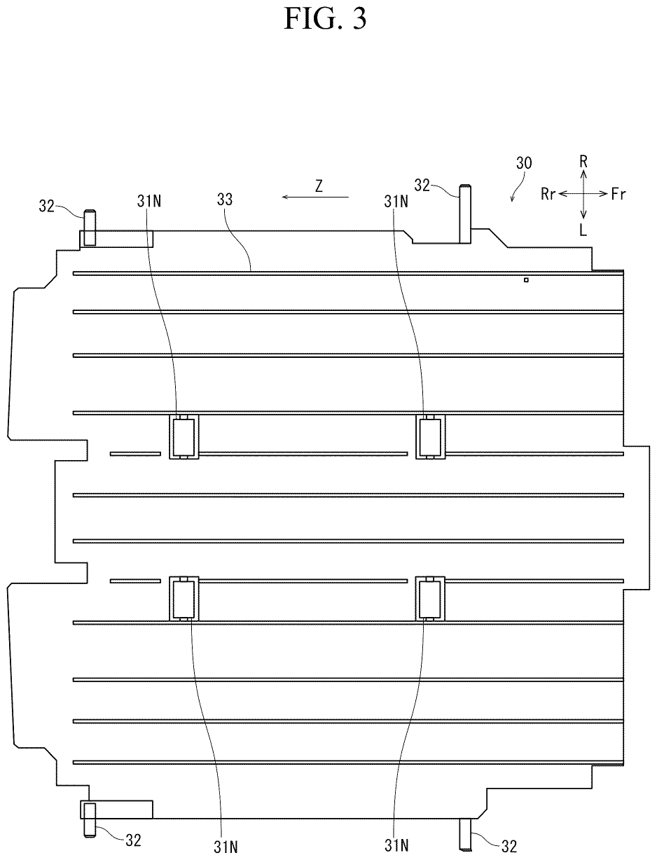

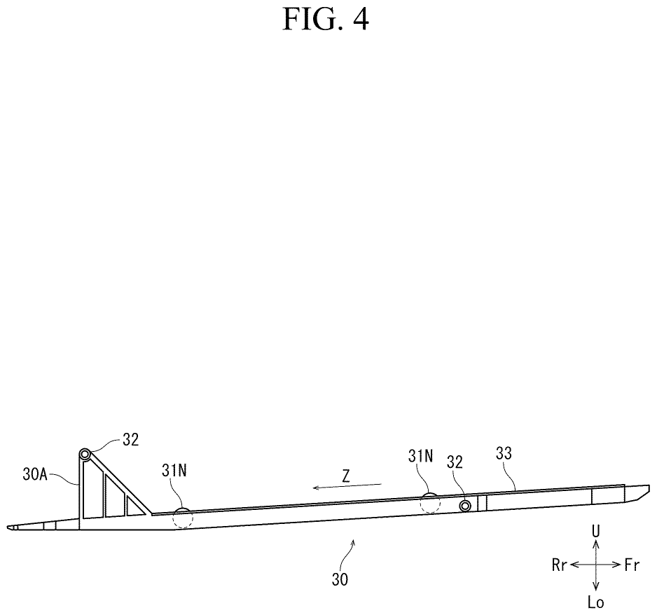

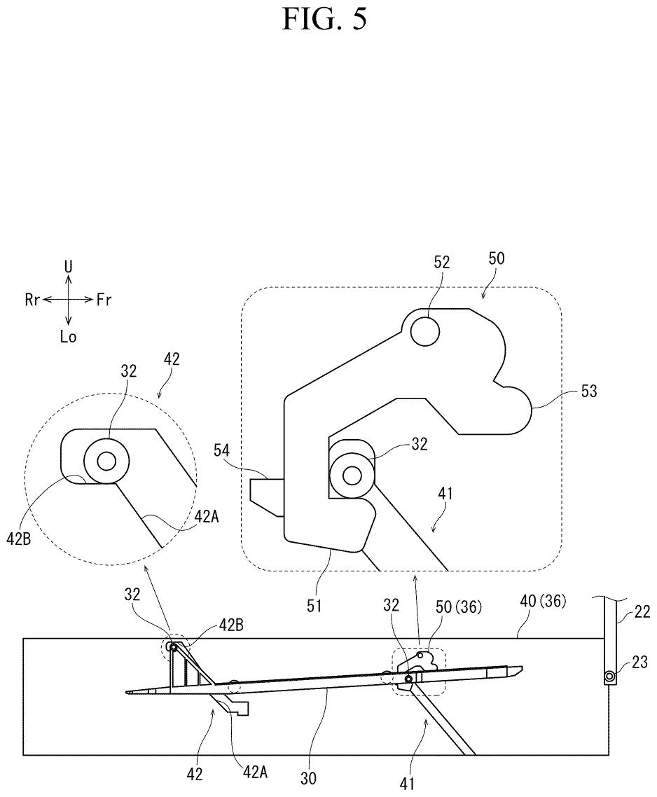

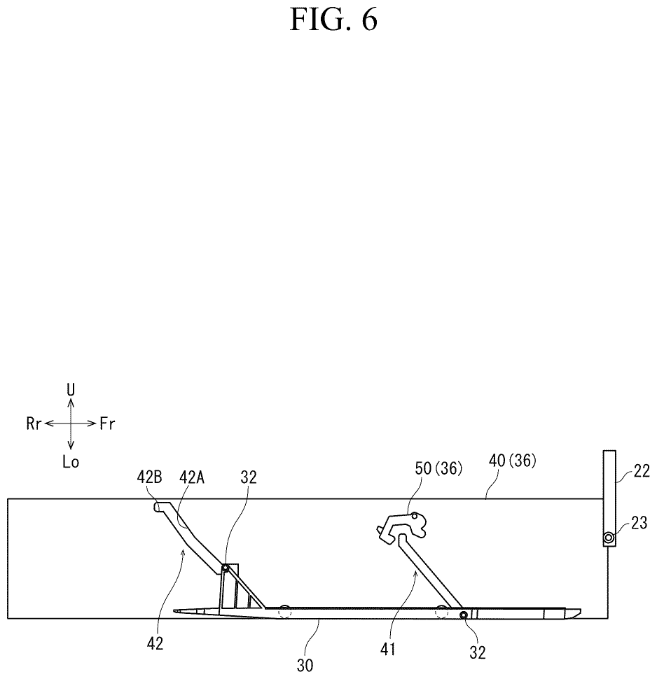

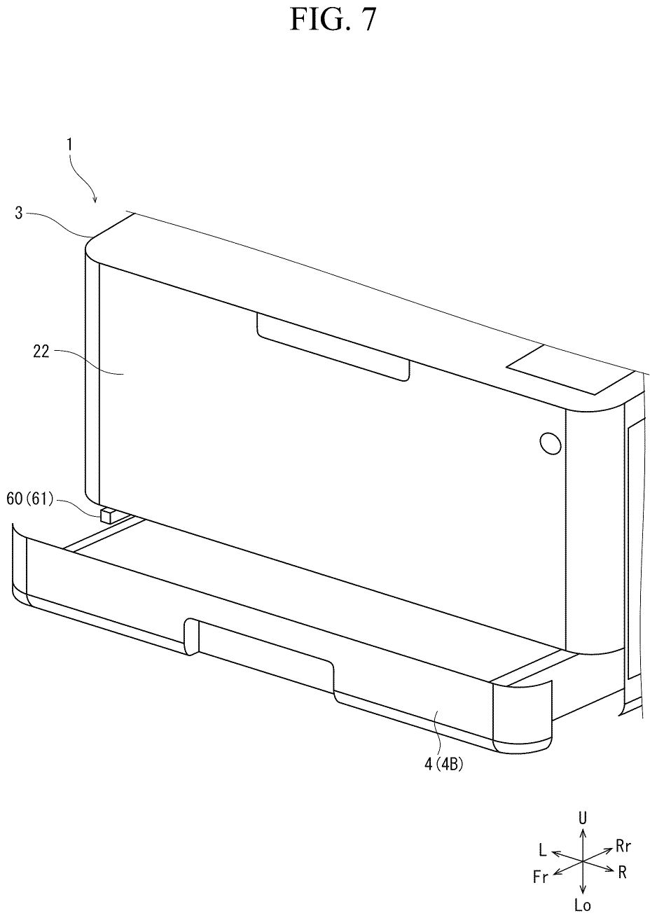

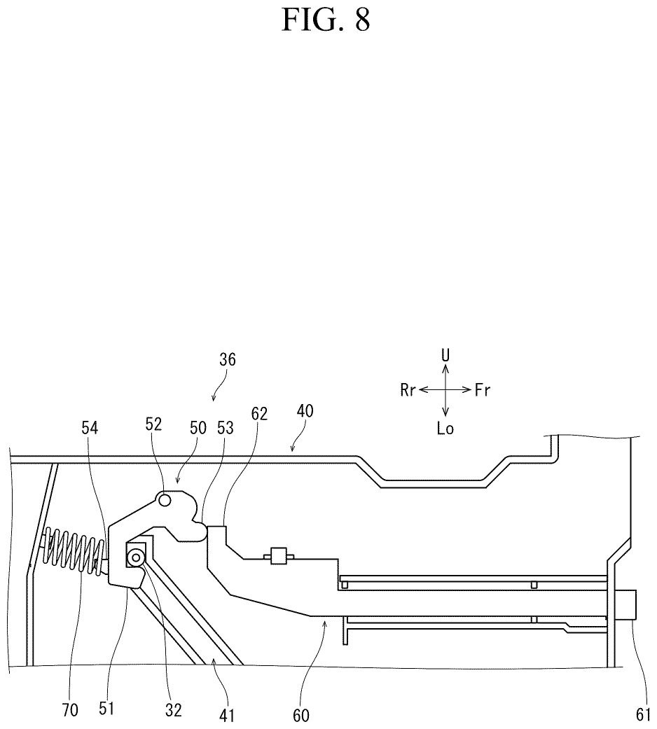

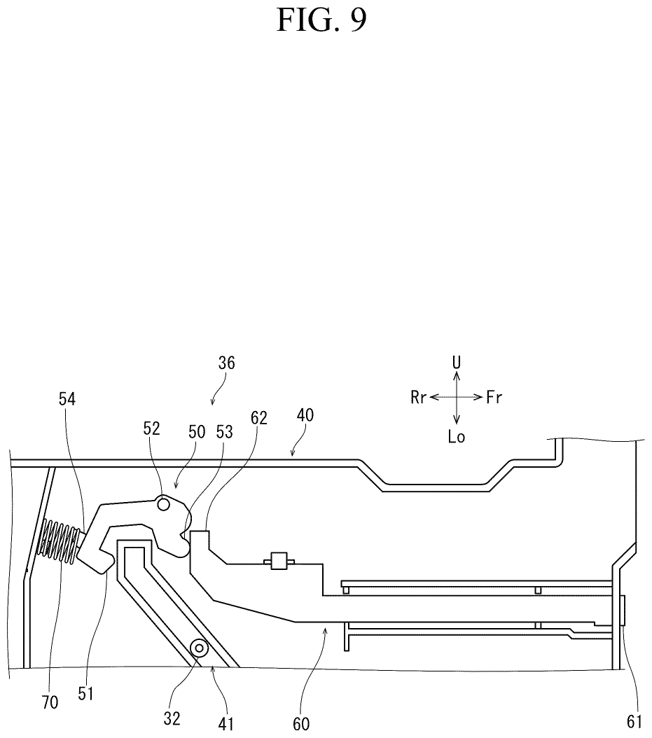

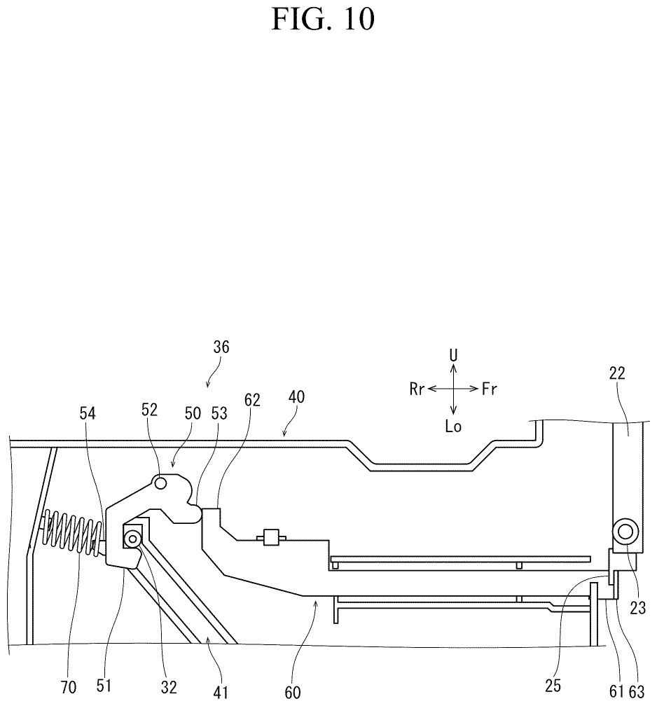

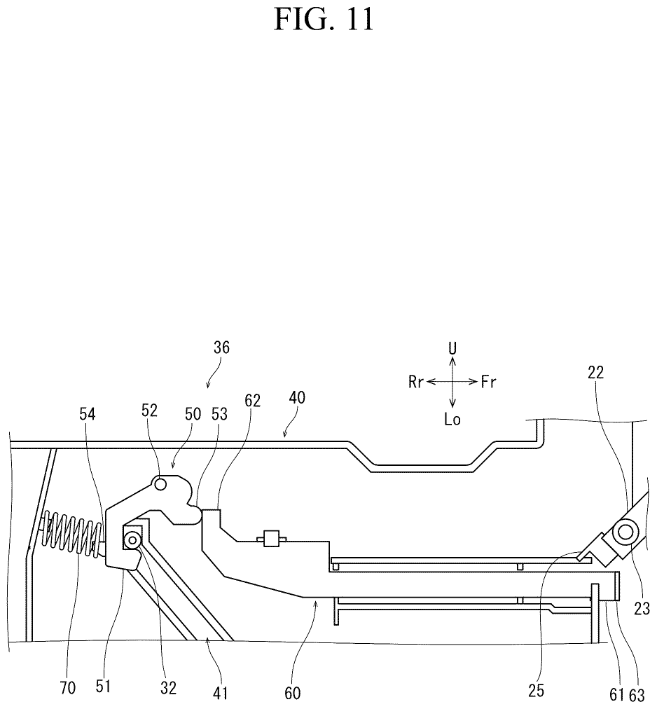

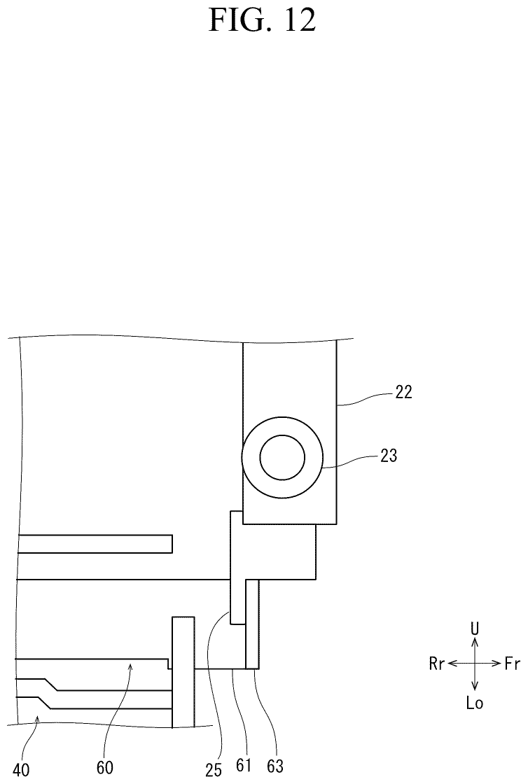

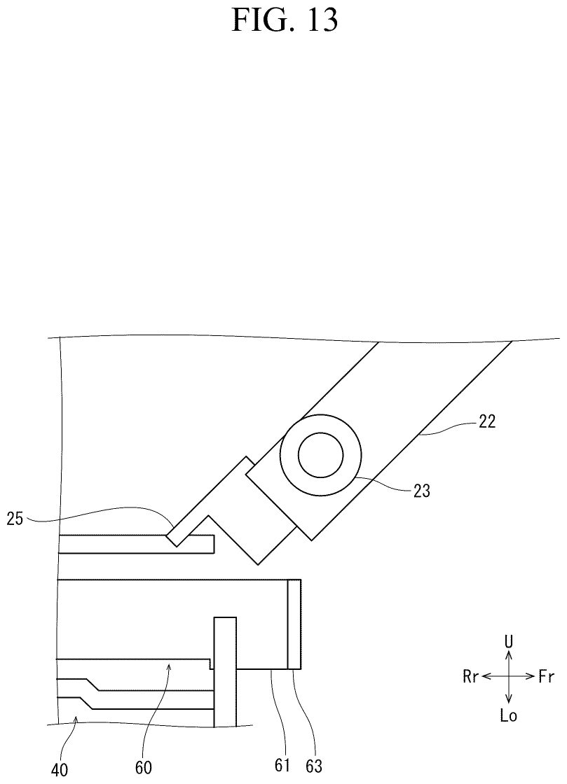

FIG. 3 is a plan view showing the conveying guide 30. FIG. 4 is a left side view showing the conveying guide 30. FIG. 5 is a left side view showing a supporting section 36 in a first state. FIG. 6 is a left side view showing the supporting section 36 in a second state. FIG. 7 is a perspective view showing the sheet feed cartridge 4 in an extended condition. FIG. 8 is a left side view showing the supporting section 36 and an operation section 60 in a conventional first state. FIG. 9 is a left side view showing the supporting section 36 and the operation section 60 in a conventional second state. FIG. 10 is a left side view showing the supporting section 36 and the operation section 60 in the first state according to the present embodiment. FIG. 11 is a left side view showing the supporting section 36 and the operation section 60 in the second state according to the present embodiment. FIG. 12 is an enlarged left side view of an engaging section 25 of FIG. 10. FIG. 13 is an enlarged left side view of the engaging section 25 of FIG. 11.

The image forming apparatus 1 comprises the conveying guide 30, the supporting section 36, the sheet feed cartridge 4, the operation section 60, the openable/closable cover 22, and the engaging section 25. The conveying guide 30 faces to a lower surface of the sheet S fed from the opening 21 provided on the side surface of the main body housing 3. The supporting section 36 is changed into the first state in which the conveying guide 30 is supported at a predetermined position and the second state in which the conveying guide 30 is lowered from the predetermined position. The sheet feed cartridge 4 is provided below the conveying guide 30 and is insertable/removable to the main body housing 3. The operation section 60 is provided at a position exposed when at least a part of the sheet feed cartridge 4 is pulled out and receives operation for changing the supporting section 36 from the first state to the second state. The cover 22 is provided on the opening 21. The engaging section 25 is engaged with the operation section 60 at a position corresponding to the first state when the cover 22 is closed and is not engaged with the operation section 60 when the cover 22 is opened.

### Conveying Guide

The conveying guide 30 (see FIGS. 3 to 6) constitutes the manual feed conveying path 10M. The conveying guide 30 faces to the lower surface of the sheet S fed from the opening 21 provided on the side surface (in the present embodiment, a front side surface) of the main body housing 3. The conveying guide 30 is formed in a plate shape.

The conveying roller 31 (see FIG. 2) includes a driving roller 31D driven by a motor or the like (not shown), and a driven roller 31N driven by being pressed against the driving roller 31D. The driven rollers 31N are provided at a plurality of positions in the conveyance direction Z of the conveying guide 30. The driving roller 31D is supported by the main body housing 3.

At two positions in front and rear sides of a right end part of the conveying guide 30, bosses 32 protruding rightward are provided. At two positions in front and rear sides of a left end part of the conveying guide 30, bosses 32 protruding leftward are provided. The left and right bosses 32 at the front side are provided at both left and right ends of the conveying guide 30. On the other hand, the left and right bosses 32 at the rear side are provided at upper ends of upright portions 30A which are upright upward from the left and right ends of the conveying guide 30. At a plurality of positions in the left and right directions on an upper surface of the conveying guide 30, ribs 33 extending in the front and rear directions are provided.

### Supporting Section

The supporting section 36 (See FIGS. 5 and 6) changes into the first state in which the conveying guide 30 is supported at the predetermined position and the second state in which the conveying guide 30 is lowered from the predetermined position. The predetermined position is a position corresponding to a lower boundary of the manual feed conveying path 10M for feeding the sheet S from the opening 21 toward the sheet feeding roller 5. The supporting section 36 includes a frame 40 and a hook 50.

### Frame

The frames 40 are provided on the left and right inner surfaces of the main body housing 3. The frame 40 may be a member separate from the main body housing 3, or may be integrally molded with the main body housing 3. The frame 40 includes a first guide groove 41 and a second guide groove 42 provided behind the first guide groove 41.

The first guide groove 41 is formed substantially linearly and is inclined so that the front side is lower than the rear side. The second guide groove 42 has a linear inclined portion 42A inclined similarly to the first guide groove 41, and a horizontal portion 42B formed substantially horizontally backward from an uppermost part of the inclined portion 42A. The horizontal portion 42B is provided at a position higher than an uppermost part of the first guide groove 41. The left and right bosses 32 at the front side of the conveying guide 30 are inserted into the first guide groove 41. The left and right bosses 32 at the rear side of the conveying guide 30 are inserted into the second guide groove 42.

In the first state, the left and right bosses 32 at the front side of the conveying guide 30 are held at the uppermost part of the first guide groove 41, and the left and right bosses 32 at the rear side of the conveying guide 30 are held at the horizontal portion 42B of the second guide groove 42. In the first state, the conveying guide 30 is inclined so that a rear end part of the upper surface of the conveying guide 30 is lower than a front end part, and the sheet S is fed from the rear end part of the upper surface of the conveying guide 30 to the sheet feeding roller 5.

In the second state, the left and right bosses 32 at the front side are lowered along the first guide groove 41, and the left and right bosses 32 at the rear side are lowered along the second guide groove 42. As a result, the conveying guide 30 lands on a bottom part of the main body housing 3.

### Hook

The hook 50 is provided on at least one of the right and left frames 40. In the present embodiment, as an example, the hook 50 is provided on the left frame 40. The hook 50 has a hook-shaped portion 51, a shaft 52, and pressing portions 53, 54. The hook-shaped portion 51 is formed in a hook-like shape and holds the front boss 32. The shaft 52 is provided along the left and right directions as an axial direction, and supports the hook-shaped portion 51 in a swingable manner. The pressing portion 53 is pressed backward by the operation section 60 (see below for details) provided in front of the hook 50. The pressing portion 54 is pressed forward by a biasing section 70 provided behind the hook 50. The biasing section 70 is, for example, a compression coil spring.

### Sheet Feed Cartridge

The sheet feed cartridge 4 (see FIGS. 1, 2 and 7) is provided below the conveying guide 30 and is insertable/removable to the main body housing 3. The sheet feed cartridge 4 is expandable in an inserting/removing direction (in the present embodiment, the front and rear directions). The sheet feed cartridge 4 has a main body portion 4A constituting a rear part of the sheet feed cartridge 4 and a slide portion 4B constituting a front part of the sheet feed cartridge 4. The slide portion 4B is slidable with respect to the main body part 4A in the inserting/removing direction. For example, the sheet feed cartridge 4 is used in a shortest state (a normal length) when the sheet S of A4 size is stored, and the sheet feed cartridge 4 is extended when the sheet S of a legal size is stored.

### Operation Section

The operation section 60 (see FIGS. 7 to 9) is provided inside the main body housing 3. The operation section 60 is formed in a rod shape as a whole, and is arranged in the front and rear directions as a longitudinal direction. One end part 61 (in the present embodiment, a front end part) of the operation section 60 is located near a front end part of the sheet feed cartridge 4, and the other end part 62 (in the present embodiment, the rear end part) of the operation section 60 is opposed to the hook 50. The operation section 60 is supported by the frame 40 so as to be slidable in the front and rear directions.

The operation section 60 is provided at a position to be exposed when at least a part of the sheet feed cartridge 4 is pulled out. Here, the “when at least a part of the sheet feed cartridge 4 is pulled out” means a case where the whole of the sheet feed cartridge 4 is pulled out from the main body housing 3, a case where a part of the front side of the sheet feed cartridge 4 is pulled out to the front side of the main body housing 3 without extending the sheet feed cartridge 4, and a case where a part of the front side of the sheet feed cartridge 4 is pulled out to the front side of the main body housing 3 by extending the sheet feed cartridge 4.

For example, FIG. 7 shows the sheet feed cartridge 4 in a state extended to a length corresponding to the legal size, and at this time, a part of the front side of the sheet feed cartridge 4, that is, the slide portion 4B is pulled out to the front side of the main body housing 3. In this case, as shown in FIG. 7, the one end part 61 of the operation section 60 is exposed, and operation for changing the supporting section 36 from the first state to the second state becomes possible.

### Conventional Action

In the first state (See FIGS. 5 and 8), the hook-shaped portion 51 of the hook 50 is in a forward opened posture. The front boss 32 of the conveying guide 30 is held by the hook-shaped portion 51 of the hook 50. The rear boss 32 of the conveying guide 30 is held by the horizontal portion 42B of the second guide groove 42. Since the pressing portion 54 of the hook 50 is pressed forward by the biasing section 70, the conveying guide 30 is held at the predetermined position. The operation section 60 is pushed forward by the pressing portion 53 of the hook 50.

When at least a part of the sheet feed cartridge 4 is pulled out, the operation section 60 is exposed and operation for pushing backward of the operation section 60 is allowed. When the operation section 60 is pushed backward, the supporting section 36 shifts to the second state.

In the second state (See FIGS. 6 and 9), the pressing portion 53 of the hook 50 is pushed backward by the operation section 60, and the hook-shaped portion 51 of the hook 50 is in a downward opened posture. Therefore, the front boss 32 of the conveying guide 30 is not held by the hook-shaped portion 51, the right and left bosses 32 at the front side are lowered along the first guide groove 41, and the right and left bosses 32 at the rear side are lowered along the second guide groove 42. As a result, the conveying guide 30 lands on the bottom part of the main body housing 3. To return the conveying guide 30 to the predetermined position, the conveying guide 30 is lifted along the first guide groove 41 and the second guide groove 42, and the front boss 32 is inserted into the hook-shaped portion 51. When the hook 50 is pressed forward by the biasing section 70, the conveying guide 30 is held at the predetermined position.

However, when the conveying guide 30 does not need to be lowered, the conveying guide 30 may be lowered. For example, in a case where the sheet feed cartridge 4 can be extended to accommodate the sheet S of a legal size or the like, since the operation section 60 is exposed when the sheet feed cartridge 4 is extended, there is a possibility that the user erroneously pushes the operation section 60 to lower the conveying guide 30 during sheet feeding from the sheet feed cartridge 4, thereby stopping sheet feeding.

Moreover, when the sheet S is replenished to the sheet feed cartridge 4 or when the sheet S clogged in the inner side of the sheet feed cartridge 4 is removed, the operation section 60 is exposed by pulling out the sheet feed cartridge 4. If the conveying guide 30 is erroneously lowered, it becomes an obstacle to work, so that it is necessary to return the conveying guide 30 to the predetermined position. Further, if the conveying guide 30 is erroneously lowered while a hand is inserted to remove the sheet S, the conveying guide 30 may come into contact with the hand.

By contrast, in the present embodiment, by a configuration described below, when it is not necessary to lower the conveying guide 30, the operation section 60 is disabled.

### Engaging Section

The engaging section 25 (see FIGS. 10 to 13) engages with the operation section 60 at a position corresponding to the first state when the cover 22 is closed, but does not engage with the operation section 60 when the cover 22 is opened. The engaging section 25 is provided on the cover 22 and is engaged with the operation section 60 by rotation of the cover 22 around the hinge 23.

Specifically, the engaging section 25 is provided at an end part of the cover 22 at a side of the hinge 23. The engaging section 25 protrudes downward from the cover 22 in a closed posture of the cover 22. The one end part 61 (the front end part) of the operation section 60 is provided with an engaged section 63 to be engaged with the engaging section 25 when the cover 22 is closed. In the present embodiment, the engaged section 63 protrudes leftward from the one end part 61 of the operation section 60, or alternatively, may protrude rightward or upward.

When the cover 22 is closed (see FIG. 12), since the engaging section 25 is located behind the engaged section 63 and engaged with the engaged section 63, operation for pushing of the operation section 60 backward is prevented. When the cover 22 is opened (see FIG. 13), the engaging section 25 moves to a rear upper side of the engaged section 63 and is not engaged with the engaged section 63, so that operation of pushing backward of the operation section 60 is allowed.

When manual feeding the sheet S, the user opens the cover 22 and stacks the sheet S on the upper surface of the cover 22. In this case, the engaging section 25 is not engaged with the engaged section 63. When the sheet S is clogged in the manual feed conveying path 10M, the user first pulls out the sheet feed cartridge 4 to expose the operation section 60. Next, the operation section 60 is pushed to lower the conveying guide 30 from the predetermined position. By this operation, holding of the sheet S by the conveying roller 31 is released, and a space above the conveying guide 30 is widened, so that removing of the sheet S allowed.

On the other hand, in a case of replenishing the sheet S to the sheet feed cartridge 4 or a case of removing the sheet S clogged in the inner side of the sheet feed cartridge 4, the sheet feed cartridge 4 is pulled out, but in this case, it is not necessary to open the cover 22. By leaving the cover 22 unopened, a state in which the engaging section 25 is engaged with the engaged section 63 is maintained. Therefore, the operation section 60 exposed by pulling of the sheet feed cartridge 4 is disabled, and even if the user erroneously touches the operation section 60, it is possible to prevent lowering of the conveying guide 30. Therefore, the sheet S can be removed without being disturbed by the conveying guide 30. Further, it is possible to prevent the conveying guide 30 from coming down and coming into contact with the hand of the user during removing work.

In addition, when the sheet feed cartridge 4 is extended, the operation section 60 is exposed, but also in this case, it is not necessary to open the cover 22. By leaving the cover 22 unopened, the state in which the engaging section 25 is engaged with the engaged section 63 is maintained. Therefore, the operation section 60 exposed by extending of the sheet feed cartridge 4 is disabled, and even if the user erroneously touches the operation section 60, it is possible to prevent lowering of the conveying guide 30.

The above-described image forming apparatus 1 according to the present embodiment comprises the conveying guide 30, the supporting section 36, the sheet feed cartridge 4, the operation section 60, the cover 22, and the engaging section 25. The conveying guide 30 faces to the lower surface of the sheet S fed from the opening 21 provided on the side surface of the main body housing 3. The supporting section 36 is changed into the first state in which the conveying guide 30 is supported at the predetermined position and the second state in which the conveying guide 30 is lowered from the predetermined position. The sheet feed cartridge 4 is provided below the conveying guide 30 and is insertable/removable to the main body housing 3. The operation section 60 is provided at a position exposed when at least a part of the sheet feed cartridge 4 is pulled out and receives operation for changing the supporting section 36 from the first state to the second state. The cover 22 is provided openably/closably on the opening 21. The engaging section 25 is engaged with the operation section 60 at a position corresponding to the first state when the cover 22 is closed, but is not engaged with the operation section 60 when the cover 22 is opened. According to the present embodiment, the conveying guide 30 can be prevented from being lowered when the conveying guide 30 does not need to be lowered.

Moreover, in the image forming apparatus 1 according to the present embodiment, the sheet feed cartridge 4 is expandable in the inserting/removing direction. According to the present embodiment, when the sheet feed cartridge 4 is extended, the operation section 60 is exposed, but lowering of the conveying guide 30 can be prevented by leaving the cover 22 unopened.

Moreover, in the image forming apparatus 1 according to the present embodiment, the cover 22 is connected to the main body housing 3 via the hinge 23, and the engaging section 25 is provided on the cover 22 and is engaged with the operation section 60 by rotation of the cover 22 around the hinge 23. According to the present embodiment, the engaging section 25 can be engaged with the operation section 60 only by closing the cover 22.

The above-described embodiment may be modified as follows.

Although the above-described embodiment represents an example that the image forming apparatus 1 is a color printer, the image forming apparatus 1 may be a monochrome printer. In addition, although the above-described embodiment represents an example that the image forming apparatus 1 is a printer in an electrophotographic system, the image forming apparatus 1 may be a printer in an inkjet system.

What is claimed is:

1. An image forming apparatus comprising:
a conveying guide facing to a lower surface of a sheet fed from an opening provided on a side surface of a main body housing;
a supporting section being changed into a first state in which the conveying guide is supported at a predetermined position and a second state in which the conveying guide is lowered from the predetermined position;
a sheet feed cartridge being provided below the conveying guide and being insertable/removable to the main body housing;
an operation section being provided at a position exposed when at least a part of the sheet feed cartridge is pulled out and receiving operation for changing the supporting section from the first state to the second state;
a cover being provided openably/closably on the opening; and
an engaging section being engaged with the operation section at a position corresponding to the first state when the cover is closed, but being not engaged with the operation section when the cover is opened.

2. The image forming apparatus according to claim 1, wherein
the sheet feed cartridge is expandable in an inserting/removing direction.

3. The image forming apparatus according to claim 1, wherein
the cover is connected to the main body housing via a hinge, and
the engaging section is provided on the cover and is engaged with the operation section by rotation of the cover around the hinge.

4. The image forming apparatus according to claim 3, wherein
the sheet feed cartridge is configured to be pulled out forward,
the operation section has one end part located near a front end part of the sheet feed cartridge, is supported to be slidable in front and rear directions, and is configured to shift the supporting section to the second state when being pushed backward, and
the engaging section protrudes downward from the cover in a closed posture of the cover to engage with an engaged section provided on the one end part.
